(19) United States
(12) Patent Application Publication
(10) Pub. No.: US 2020/0108551 A1
(43) Pub. Date: Apr. 9, 2020

(54) DAMPED ARTICLES AND SYSTEMS AND TECHNIQUES FOR FORMING DAMPED ARTICLES

(71) Applicants: Rolls-Royce North American Technologies, Inc., Indianapolis, IN (US); Rolls-Royce Corporation, Indianapolis, IN (US)

(72) Inventors: Andrew James Eifert, Indianapolis, IN (US); Bradford J. Riehle, Plainfield, IN (US); Ryan C. Humes, Indianapolis, IN (US); Emma Mitchell, Indianapolis, IN (US)

(21) Appl. No.: 16/154,441

(22) Filed: Oct. 8, 2018

(51) Int. Cl. B29C 64/153; B29C 64/245; B22F 3/105

(52) U.S. Cl. CPC B29C 64/153; B29L 2031/721; B22F 3/1055; B29C 64/245

(57) ABSTRACT

An example article includes a body. The body defines at least one damping pocket, at least one body opening defined in an outer surface of the body, and an at least one escape channel. The at least one damping pocket is fluidically coupled to the at least one body opening by the at least one escape channel. The article includes a predetermined volume of damping material enclosed in the at least one damping pocket. An example technique includes additively manufacturing the article including the body. An example system includes an additive manufacturing tool, and a computing device configured to control the additive manufacturing tool to additively manufacture the article including the body.

### TECHNICAL FIELD

The disclosure relates to damped articles, in particular, to additive manufacturing of damped articles.

### BACKGROUND

Additive manufacturing generates three-dimensional structures through addition of material layer-by-layer or volume-by-volume to form the structure, rather than removing material from an existing volume to generate the three-dimensional structure. Additive manufacturing may be advantageous in many situations, such as rapid prototyping, forming components with complex three-dimensional structures, or the like. In some examples, additive manufacturing may include fused deposition modeling, in which heated material, such as polymer, is extruded from a nozzle and cools to be added to the structure, or stereolithography, in which an energy source is used to selectively cure a liquid photopolymer resin to a desired shape of the component.

Components susceptible to vibrations or oscillations may experience increased wear and stress, or may not comply with operational specifications.

### SUMMARY

The disclosure describes example damped articles, and techniques and systems for manufacturing damped articles.

In some examples, the disclosure describes an article including a body. The body defines at least one damping pocket, at least one body opening defined in an outer surface of the body, and at least one escape channel. The at least one damping pocket is fluidically coupled to the at least one body opening by the at least one escape channel. The article includes a predetermined volume of damping material enclosed in the at least one damping pocket.

In some examples, the disclosure describes an example technique including additively manufacturing an article including a body. The body defines at least one damping pocket, at least one body opening defined in an outer surface of the body, and at least one escape channel. The at least one damping pocket is fluidically coupled to the at least one body opening by the at least one escape channel. The example technique includes filling the at least one damping pocket with a predetermined volume of damping material.

In some examples, the disclosure describes an example system including an additive manufacturing tool and a computing device. The computing device is configured to control the additive manufacturing tool to additively manufacture an article comprising a body. The body defines at least one damping pocket, at least one body opening defined in an outer surface of the body, and at least one escape channel. The at least one damping pocket is fluidically coupled to the at least one body opening by the at least one escape channel. The computing device is configured to control the additive manufacturing tool to fill the at least one damping pocket with a predetermined volume of damping material.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual perspective view of an example article including a body including a damping pocket and an escape channel fluidically connected to the damping pocket.

FIG. 1B is a conceptual cross-sectional view of an initial configuration of the article of FIG. 1A.

FIG. 1C is a conceptual cross-sectional view of an intermediate configuration of the article of FIG. 1A.

FIG. 1D is a conceptual cross-sectional view of a final configuration of the article of FIG. 1A.

FIG. 2A is a conceptual perspective view of an example article including a body including a damping pocket and an escape pocket fluidically connected to the damping pocket.

FIG. 2B is a conceptual cross-sectional view of an initial configuration of the article of FIG. 2A.

FIG. 2C is a conceptual cross-sectional view of a first intermediate configuration of the article of FIG. 2A.

FIG. 2D is a conceptual cross-sectional view of a second intermediate configuration of the article of FIG. 2A.

FIG. 2E is a conceptual cross-sectional view of a third intermediate configuration of the article of FIG. 2A.

FIG. 2F is a conceptual cross-sectional view of a final configuration of the article of FIG. 2A.

FIG. 3 is a conceptual block diagram illustrating an example system for additive manufacturing of example articles including damping pockets.

FIG. 4 is a flow diagram illustrating an example technique for additive manufacturing of example articles including damping pockets.

### DETAILED DESCRIPTION

The disclosure generally describes articles including damping pockets, and systems and techniques for forming articles including damping pockets. Articles, for example, industrial components, may be damped to reduce their susceptibility to oscillations or vibrations and the like. The articles described herein may be internally damped. For example, an article may include a damping pocket configured to damp the article. The damping pocket may enclose a suitable damping material, for example, a material configured to at least partly absorb vibrations, mechanical shock, and the like.

Introducing a damping material into a damping pocket of an article may pose challenges. For example, the article may have a complex or intricate geometry, and a suitable location for a damping pocket may not be accessible, or accessible locations may not provide sufficient damping. Additionally, if a damping material is very closely packed, it may not exhibit sufficient damping as it may absorb vibrations less efficiently. An article including a damping pocket may be processed by techniques that may further pack or compress a damping material in the damping pocket, leading to packing. Such a compressed or packed damping material may not absorb vibrations or oscillations, and instead allow them to pass through.

In examples according to the disclosure, additive manufacturing may be used to introduce damping material into a damping pocket during forming the article. In this way, regardless of the location of the damping pocket, a damping material may be introduced into the damping pocket. Moreover, in examples according to the disclosure, articles may include an escape channel fluidically connected to the damping pocket, to allow a predetermined amount of damping material to be removed from the damping pocket. Removing some material from the damping pocket may leave a corresponding void in the damping pocket. The void may allow movement or migration of damping material, or otherwise provide room for the damping material to move, avoiding compression or packing of the damping material.

In some examples, the disclosure describes an article including a body. The body defines at least one body opening, at least one damping pocket, and at least one escape channel. The at least one damping pocket includes a predetermined volume of damping material. The at least one damping pocket is fluidically coupled to the at least one body opening by the at least one escape channel.

The article may be moved or reoriented such that a predetermined portion of the predetermined volume of damping material is allowed to escape the damping pocket through the escape channel, for example, by gravitational forces or other forces. Removal of the predetermined portion of damping material may introduce a complementary void in the damping pocket. The remaining portion of damping material is free to move or otherwise avoid a packed configuration in the damping pocket. After a sufficient void volume is introduced in the damping pocket, the escape channel or an opening defined by the escape channel may be sealed, to prevent further escape of damping material from the damping pocket. In this way, problems associated with packed damping material may be avoided or reduced, and the article may be more effectively damped.

In some examples, the disclosure describes an example technique including additively manufacturing an article including a body. Additive manufacturing may allow defining a damping pocket and introducing damping material in the damping pocket during manufacture or formation of the article, so that the as-built article includes a damping pocket including a damping material. In this way, problems associated with introducing a damping material into a damping pocket after manufacturing or forming the article may be reduced or avoided.

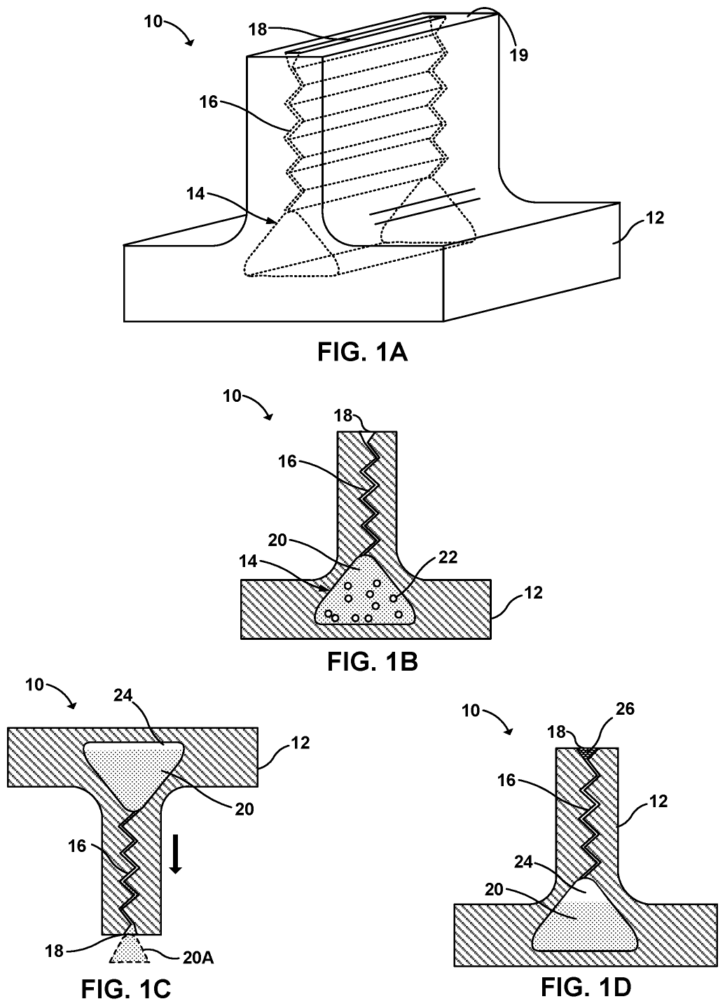

FIG. 1A is a conceptual perspective view of an example article 10 including a body 12 defining a damping pocket 14 and an escape channel 16 fluidically connected to damping pocket 14. FIG. 1B is a conceptual cross-sectional view of an initial configuration of article 10 of FIG. 1A. Article 10 may be any article susceptible to vibrations or oscillations, or otherwise to be damped. In some examples, article 10 includes an industrial component, for example, an aerospace component. Body 12 may include a component of article 10. Body 12 may include at least one of metal, alloy, plastic, ceramic, glass, or any suitable material or composition. In some examples, body 12 includes an additively manufactured component. In some examples, body 12 is a unitary body. In other examples, body 12 includes two or more pieces joined or held together.

Body 12 defines at least one damping pocket 14. Damping pocket 14 may have any suitable three-dimensional shape, for example, cuboid, rectanguloid, cylindrical, conical, spheroidal, ellipsoidal, pyramidal, or define any suitable cross-section, for example, having polygonal, curved, or curvilinear cross-section along any axis of damping pocket 14, or combinations of shapes.

Body 12 defines at least one escape channel 16, and at least one body opening 18 defined in an outer surface 19 of body 12. Damping pocket 14 is fluidically coupled to at least one body opening 18 by at least one escape channel 16.

Damping pocket 14 includes a predetermined volume of damping material 20. Damping material 20 may include any material configured to at least partially absorb vibrations or oscillations, thereby at least partially damping article 10. In some examples, damping material 20 includes at least one of unfused powder, partially fused powder, a damping component comprising at least partially fused powder, or at least one frangible shell 22. In some examples, frangible shell 22 has a hollow spheroidal or ellipsoidal shape, and is frangible or breakable. For example, frangible shell 22 may be at least partially crushed, or substantially crushed, in response to a predetermined pressure or force exerted on frangible shell 22. In some examples, at least some of damping material 20 may have the same composition as the material that forms body 12, e.g., damping material 20 may be powder used to form body 12 in an additive manufacturing process, but that is left unfused to body 12.

In some examples, damping pocket 14 may be substantially occupied by damping material 20 in an initial configuration (e.g., during initial manufacturing of article 10), so that damping material 20 substantially fills damping pocket 14, aside from volume not occupied due to packing inefficiencies, as shown in FIG. 1B. The initial configuration of article 10 in which damping material 20 substantially occupies damping pocket 14, or may be compressed or packed in damping pocket 14, may be a result of manufacturing processes, such as residual powder or material left after additively manufacturing article 10, or result of hot-isostatic processing or other processes. In such a configuration, damping material 20 may not effectively or sufficiently damp vibrations experienced by article 10 due to the compression or packing. To improve damping by damping material 20, a void of unoccupied space may be introduced into damping pocket 14.

In some examples, frangible shell 22 may be crushed, ruptured, disintegrated to introduce the unoccupied space in damping pocket 14. A force or pressure greater than a rupture threshold may be exerted on frangible shell 22 to ultimately introduce the void. For example, a void in an interior of whole frangible shell 22 may be transferred to damping pocket 14 when frangible shell 22 is crushed.

Instead of, or in addition to, introducing a void by rupture of at least one frangible shell 22, a unoccupied space may be introduced into damping pocket 14 by allowing or causing a portion of damping material 20 to escape from damping pocket 14. For example, a portion of damping material 20 may flow into or be drawn into escape channel 16, as described with reference to FIG. 1C.

FIG. 1C is a conceptual cross-sectional view of an intermediate configuration of article 10 of FIG. 1A. The intermediate configuration of article 10 shown in FIG. 1C may occur after completion of manufacturing of body 12 and filling of damping pocket 14 with damping material 20, but before completion of manufacturing of article 10. In some examples, the intermediate configuration may include a tilted configuration, or an inverted configuration of article 10 relative to a direction of gravity, such that body opening 18 is angled against the direction of gravity or faces the direction of gravity. In some such examples, gravity may cause a portion of damping material 20 to flow into or be drawn into escape channel 16, and ultimately escape from damping pocket 14 and body 12 via body opening 18 as escaped volume 20A of damping material 20, as shown in FIG. 1C. 8. In some examples, body opening 18 defines a slit, for example, a linear slit, as shown in FIGS. 1A and 1B. However, body opening 18 may define any suitable linear, curved, curvilinear shape, and may have any suitable polygonal, curved, or composite cross-section. Body opening 18 dimensioned to allow damping material 20 to escape from body opening 18. For example, a minimum transverse distance between opposing edges of body opening 18 may be sufficiently wider than the largest particles or other constituents of damping material 20, so that particles or other constituents of damping material 20 can pass through body opening 18.

In some examples, escape channel 16 includes a plurality of channel segments along an undulating, sinuosoid-like, sawtooth, or zig-zag path. Respective channel segments of the plurality of channel segments may have any suitable length, for example, substantially the same length, or different lengths. Escape channel 16 may be dimensioned to allow only a predetermined portion of the predetermined volume of damping material 20 to escape damping pocket 14 through body opening 18. For example, one or more of the average length of channel segments, average diameter of channel segments, and total length of escape channel 16 may be dimensioned to provide escape channel 16 with a predetermined escape volume. Escape channel 16 is also dimensioned to allow damping material 20 to flow into or be drawn into escape channel 16. For example, a minimum transverse diameter of the narrowest portion of escape channel 16 may be sufficiently wider than the largest particles or other constituents of damping material 20, so that particles or other constituents of damping material 20 can pass through escape channel 16. In some examples, body opening 18 may define a transverse dimension that is at least as wide as an average transverse dimension of escape channel 16, or substantially wider, to avoid blockage or flow restriction at body opening 18.

While escape channel 16 may extend along a linear path, as shown in FIGS. 1A to 1D, escape channel 16 may alternatively extend along a curved, curvilinear, or composite path. Further, escape channel 16 may also extend along a path that is inclined relative to an axis defined by damping pocket 14 and body opening 18.

In this way, a controlled escape volume 20A of damping material 20 may be withdrawn from damping pocket 14 into escape channel 16, without allowing the remaining damping material 20 to escape from damping pocket 14. In some examples, escape volume 20A is sufficient to introduce a void 24 in damping pocket 14, as shown in FIGS. 1C and 1D. The tilting or inverting may be performed once, or repeated to cause the void 24 to attain a predetermined void volume, by causing a complementary portion of damping material 20 to depart from damping pocket 14.

FIG. 1D is a conceptual cross-sectional view of a final configuration of article 10 of FIG. 1A. After the predetermined portion 20A of damping material 20 escapes from damping pocket 14, article 10 may be re-oriented so that damping material 20 no longer escapes into escape channel 16, or otherwise out from body opening 18. At least one of escape channel 16 or body opening 18 may be sealed or closed with a seal 26 to prevent further loss or escape of damping material 20 from body 12, as shown in FIG. 1D. Seal 26 may include at least one of metal, alloy, glass, ceramic, rubber, polymer, fibrous material, nonwowen material, adhesive, or the like to block at least one of escape channel 16 or body opening 18. In some examples, the composition of seal 26 is the same as body 12. Seal 26 may be formed using additive manufacturing in some examples.

Thus, in the final configuration shown in FIG. 1D, damping pocket 14 defines a pocket volume, with a predetermined volume of damping material 20 left in damping pocket 14. The predetermined volume of damping material 20 may be less than the volume of damping pocket 14 by a predetermined volume amount. For example, the difference in the respective volumes of damping material 20 and that of damping pocket 14 may substantially be the same as the volume of void 24. Thus, the volume of void 24 may be equal to the predetermined volume amount. In some examples, the predetermined volume amount may be at least 1%, or at least 5%, or at least 10%, of the pocket volume of damping pocket 14. In some examples, the predetermined volume amount may be less than 30%, or less than 20%, or less than 10%, or less than 5%, of the pocket volume of damping pocket 14. In some examples, the predetermined volume amount may be between 1% and 30%, or between 1% and 20%, or between 1% and 10%, or between 1% and 5%, or between 5% and 30%, or between 5% and 20%, or between 10% and 20%, or between 10% and 30% of the pocket volume of damping pocket 14. In some examples, the predetermined volume amount may be related to mechanical properties of damping material 20, for example, gross density, porosity, or angle of repose, or the like, which may be indicative of the ability of damping material 20 to absorb shock and vibrations.

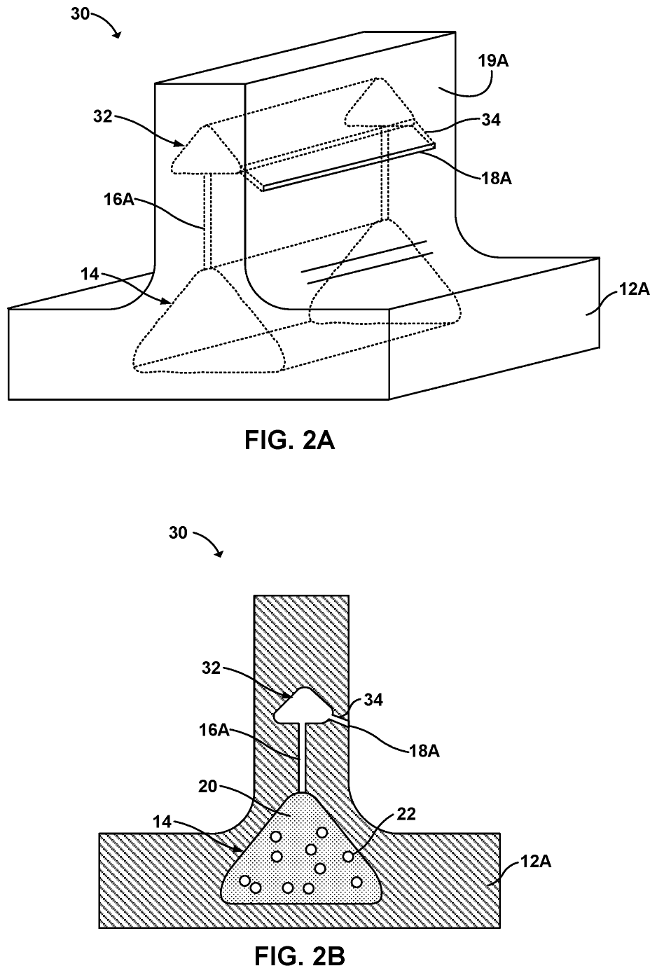

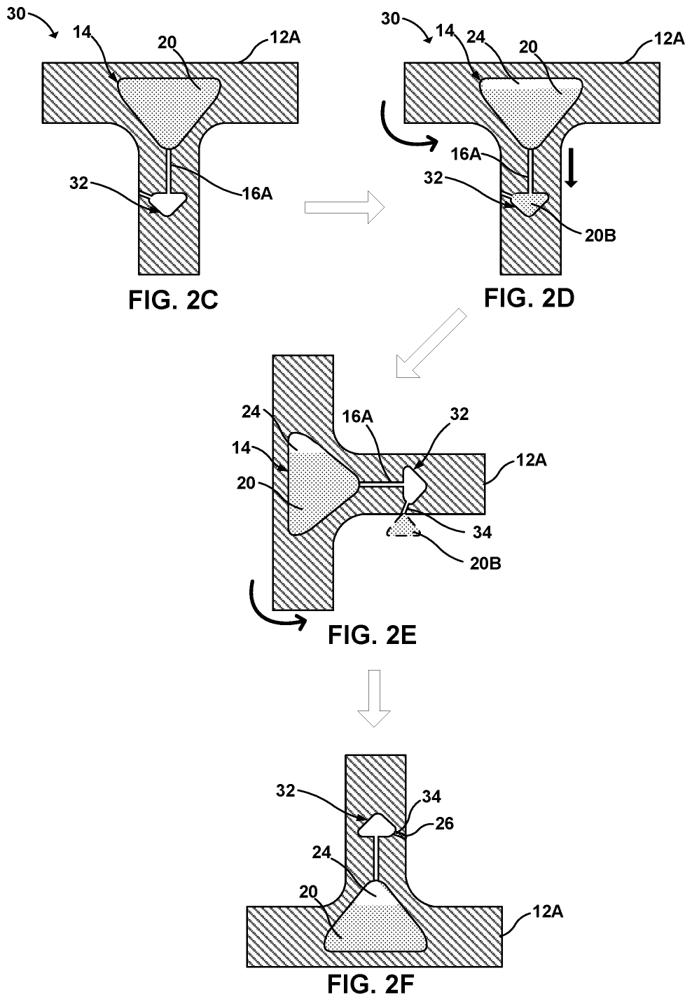

Thus, escape channel 16 may provide a tortuous path for controlled release or escape of a portion of damping material 20 from damping pocket 14. In addition to, or instead of, tortuous or undualating escape channel 16, body 12 may include an escape pocket, as described with reference to FIGS. 2A to 2F.

FIG. 2A is a conceptual perspective view of an example article 30 including a body 12A including damping pocket 14 and an escape pocket 32 fluidically connected to damping pocket 14. FIG. 2B is a conceptual cross-sectional view of an initial configuration of article 30 of FIG. 2A.

Article 30 may be substantially similar to article 10, for example, including body 12A similar to body 12, and damping material 20 in damping pocket 14. However, article 30 and article 10 may differ in the positioning of damping pocket 14, and in location of a body opening. For example, article 30 may also include an escape channel 16A and a body opening 18A defined in an outer surface 19A of body 12A. Escape channel 16A may be substantially similar to escape channel 16 described with reference to FIGS. 1A to 1D, or may substantially linear and extend along a linear path, as shown in FIGS. 2A and 2B. Likewise, body opening 18A may be substantially similar to body opening 18 described with reference to FIGS. 1A to 1D. However, article 30 may differ from article 10 in the relative positioning of damping pocket 14, escape channel 16A and body opening 18A, compared with escape channel 16 and body opening 18. For example, while damping pocket 14, escape channel 16, and body opening 18 of article 10 may extend along a straight line or path, in contrast, damping pocket 14, escape channel 16A, and body opening 18A of article 30 may define an angled path, as shown in FIGS. 2A and 2B.

Body 12A may define at least one escape pocket 32. Escape pocket 32 is fluidically coupled to at least one damping pocket 14 by at least one escape channel 16A. In some examples, escape pocket 32 may be geometrically similar to damping pocket 14, and define a smaller volume than damping pocket 14. Escape pocket 32 may have substantially the same geometric shape as damping pocket 14, or have a different shape. In some examples, escape channel 16A may be relatively short, or absent, and escape pocket 32 may be directly fluidically coupled to damping pocket 14, for example, by a neck, or by a mutual wall or opening.

Thus, escape pocket 32 is dimensioned to receive a predetermined portion of damping material 20 from damping pocket 14, for example, via escape channel 16A. Escape pocket 32 is also fluidically coupled to at least one body opening 18A. For example, body 12A may define outlet channel 34 coupling escape pocket 32 and body opening 18A. Outlet channel 34 may be similar to escape channel 16 or escape channel 16A. In some examples, outlet channel 34 is shorter in length than escape channel 16A. In other examples, outlet channel 34 is longer in length than escape channel 16A, or has substantially the same length as escape channel 16A. In some examples, escape pocket 32 is positioned relative to damping pocket 14 and body opening 18A to allow only the predetermined portion of the damping material 20 to escape damping pocket 14 through the body opening 18A.

In an initial configuration, as shown in FIG. 2B, damping material 20 may occupy substantially an entire volume of damping pocket 14. Article 30 may be rotated or inverted through a sequence of rotations described with reference to FIGS. 2C to 2F, to cause a predetermined portion of damping material 20 to ultimately escape from body opening 18A via escape pocket 32.

FIG. 2C is a conceptual cross-sectional view of a first intermediate configuration of article 30 of FIG. 2A. In the first intermediate configuration, article 30 is tilted or inverted to allow gravity (or other forces) to act on damping material 20, and initiate flow or movement of damping material 20 into escape pocket 32 and escape channel 16A.

FIG. 2D is a conceptual cross-sectional view of a second intermediate configuration of article 30 of FIG. 2A. In the second intermediate configuration, article 30 is manipulated to position article 30 so gravity causes predetermined portion 20B of damping material 20 to flow or pass through escape channel 16A into escape pocket 32. Thus, a volume of escape pocket 32 may define the volume of predetermined portion 20B that escapes from damping pocket 14. The volume of escape pocket 32 may also thus define the volume of void 24 that is introduced into damping pocket 14 as a result of migration of predetermined portion 20B of damping material 20 from damping pocket 14 to escape pocket 32.

FIG. 2E is a conceptual cross-sectional view of a third intermediate configuration of article 30 of FIG. 2A. In the third intermediate configuration, article 30 is further tilted so that gravity causes predetermined portion 20B to escape from body opening 18A through outlet channel 34 while reducing or substantially eliminating flow of additional damping material 20 from damping pocket 14 into escape channel 16A and escape pocket 32.

FIG. 2F is a conceptual cross-sectional view of a final configuration of article 30 of FIG. 2A. In the final configuration, article 30 is oriented back to an initial position or another position in which remaining damping material 20 in damping pocket 14 and void 24 are substantially retained. The configurations described with reference to FIGS. 2C to 2F may optionally be repeated one or more times, each time allowing predetermined volume 20B of damping material 20 to escape, and introducing additional void, ultimately increasing volume of void 24 by about the volume of escape pocket 32 with each cycle. After void 24 has a sufficient volume, at least one of escape channel 16A, outlet channel 34, or body opening 18A may be sealed with seal 26, to prevent further escape of damping material 20.

In this way, example articles may include a predetermined volume of damping material 20 and a predetermined relative void volume 24 in a damping pocket 14. While example articles including a single damping pocket, single escape channel, single escape pocket, single outlet channel, or single body opening have been described, in other examples, example articles may include more than one damping pocket, escape channel, escape pocket, outlet channel, or body opening. For example, multiple body openings may ultimately be fluidically connected to one or more than one damping pockets, via one or more than one escape channel, escape pocket, or outlet channel.

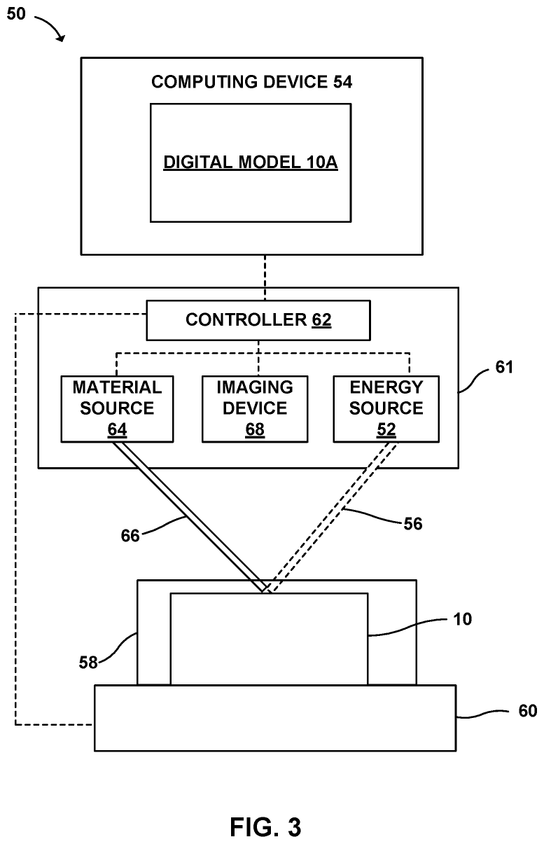

FIG. 3 is a conceptual block diagram illustrating an example system 50 for additive manufacturing of example articles including damping pockets. While example system 50 of FIG. 3 is described with reference to example article 10 of FIG. 1A, example system 50 may be used to form other example articles according to the disclosure.

System 50 includes an energy source 52 and a computing device 54. Computing device 54 may include one or more processors configured to implement functionality and/or process instructions for execution within computing device 54. For example, the processors may be capable of processing instructions stored by a storage device of computing device 54. Examples of the one or more processors may include, any one or more of a microprocessor, a controller, a digital signal processor (DSP), an application specific integrated circuit (ASIC), a field-programmable gate array (FPGA), or equivalent discrete or integrated logic circuitry.

In some examples, computing device 54 is configured to control energy source 52 to deliver an energy beam 56 toward a powder bed 58 to additively manufacture article 10 including body 12.

In some examples, system 50 may include a build platform 60 to hold powder bed 58 and partly or completely built article 10. Build platform 60 may include a container to hold powder bed 58, and to hold article 10 substantially stationary relative to build platform 60. In some examples, system 10 may not include build platform 60, and computing device 54 may control the relative position and relative orientation of energy beam 56 and article 10, for example, by controlling an industrial robot, a movable platform, or a multi-axis stage supporting the container holding powder bed 58.

Computing device 54 may control an additive manufacturing tool 61 for fabricating article 10 including body 12 including damping pocket 14 and escape channel 16. In some examples, computing device 54 may generate or store a digital representation 10A of article 10. In some examples, computing device 54 may control additive manufacturing tool 61 to fabricate article 10 based on digital representation 10A. In some examples, additive manufacturing tool 61 may include a controller 62 for controlling one or more of energy source 52, a material source 64, or an imaging device 68.

Computing device 54 may send control signals to controller 62 for controlling additive manufacturing tool 61. For example, computing device 54 may send operational signals to and receive status signals from controller 62 to control and monitor the operation of additive manufacturing tool 61. In some examples, computing device 54 may not control additive manufacturing tool 61, and controller 62 may be configured to receive signals indicative of digital representation 10A from computing device 54 and to control additive manufacturing tool 61 based on digital representation 10A to fabricate article 10.

In some examples, system 10 may initially include powder bed 58 including a predetermined volume of powder, and controller 62 may control energy source 52 to direct energy beam 56 toward powder bed 58, to form article 10. In some examples, controller 62 may control material source 64 of additive manufacturing tool 61 to direct a material stream 66 including a material toward build platform 60, for example, to deposit powder bed 58 in the container. In some examples, system 10 may not include powder bed 58. In some such examples, and controller 62 may control material source 64 to direct material stream 66 and control energy source 52 to direct energy beam toward build platform 60, to form article 10. The material in material source 64 may include metal, alloy, ceramic, polymer, or any suitable material composition for construction body 12 of article 10. Thus, controller 62 may control material source 64 of additive manufacturing tool 61 to direct material stream 66 at a build location, for example, an initial build location on a region in powder bed 58 or of build platform 60, or at a build location on partially built article 10.

Controller 62 also may control energy source 52 to direct energy beam 56 at the build location, whether in or adjacent powder bed 58, or intersecting with material stream 66 on or adjacent build platform 60. Energy beam 56 may interact with the material from material stream 66 at the build location, for example, by fusing, melting, sintering, curing, solidifying or otherwise modifying the material at the build location to cause the material to be joined to other material of partly built article 10 at the build location, or to material in powder bed 58. Energy beam 66 may include any energy, for example, ultraviolet light, electron beam, plasma, or laser, that may interact with the material to change a state of the material. For example, energy beam 66 may be focusable or directable towards the material in material stream 66. In some examples, the build location at which energy beam 56 interacts with material stream 66 is adjacent an existing surface of partly-built article 10 or region of powder bed 58 such that the material is added to article 10. In some examples, controller 62 may control energy source 52 to emit a diffuse energy beam, or a patterned array of beams, for example, a light pattern. The build location may change as article 10 is fabricated, for example, along regions or surfaces of partly fabricated article 10.

In some examples, controller 62 may cause additive manufacturing tool 61 to fabricate article 10 by depositing the material at different build locations along a tool path, so that the material is ultimately deposited or joined along a predetermined build direction, for example a vertical build direction upwards (for example, against a gravitational force) or downwards (for example, toward a gravitational force).

In some examples, build platform 60 may remain stationary as article 10 is fabricated. In other examples, build platform 60 may be movable or rotatable, for example, along multiple axes, and controller 62 may control the position of build platform 60. In some examples, controller 62 may successively move build platform 60 against the build direction, or to change the build location by changing the orientation of build platform 60, and that of article 10, relative to material stream 66 and energy beam 56.

In some examples, controller 62 may separately control energy source 52 and material source 64, for example, by separately controlling material source 64 to direct material stream 66 to deposit a layer or volume of the material, and then controlling energy source 52 to direct energy beam 56 along a series of build locations within the deposited layer or volume of the material to energize the material at the build locations to fabricate article 10. Therefore, controller 62 may direct build location along a two-dimensional or three-dimensional tool path to fabricate article 10 based on digital representation 10A.

In some examples, system 50 may not include material source 64, and instead, energy beam 56 may energize or fuse material previously deposited to define powder bed 58. In other examples, material source 64 may contain and direct material to deposit damping material 20. For example, article 10 may be built from powder in powder bed 58, while damping material 20 may be deposition by intermittently depositing material from material source 64 as article 10 is being built, for example, into partly defined damping pocket 14. In some examples, material source 64 may house more than one material, for example, at least one of a first material for building article 10, a second material for depositing damping material 20, or a third material for depositing or forming frangible shells 22. In some examples, system 10 may not include a separate material for depositing or forming frangible shells 22, and frangible shells 22 may be formed from the material for building article 10 or the material for damping material 20. In some examples, system 10 may not include a separate material for depositing or forming damping material 20, and damping material 20 may include residual unfused or partially fused powder or material remaining in powder bed 58 or otherwise on or adjacent platform 60. The remaining material may be identical to a material used for building article 10, and may be delivered by material source 64.

In some examples, controller 62 may control imaging device 68 to image surfaces or regions or volumes of one or more of article 10, the build location, or platform 60 to generate respective build images periodically or continuously. Controller 62 may periodically or continuously compare the build images with the digital representation 10A to verify that article 10 substantially conforms (e.g., conforms or nearly conforms) to digital representation 10A. In some examples, controller 62 may control one or more of material source 64, energy source 52, and build platform 60 based on the build images and the digital representation 10A. For example, controller 62 may be configured to control build energy source 52, platform 60, material source 64, and/or imaging device 68 to translate and/or rotate along at least one axis to position platform 60 relative to material stream 64, energy beam 56, and/or imaging device 68. Positioning platform 60 relative to material stream 66, energy beam 56, and/or imaging device 68 may include positioning a predetermined surface or region (e.g., a surface to which material is to be added) of article 10, powder bed 58, or platform 60 in a predetermined orientation relative to energy source 52, material source 64, and/or imaging device 68, so that material is added in regions or volumes defined by digital representation 10A.

In some examples, computing device 54 may perform one or more functions described with reference to controller 62. In some such examples, additive manufacturing tool 61 may not include controller 62, and computing device 54 may control one or more of energy source 52, material source 54, imaging device 68, and build platform 60, instead of controller 62.

Example system 50 discussed above may be used to fabricate example articles described above with reference to FIGS. 1A to 2F. However, example system 50 may be used to fabricate any example articles according to the disclosure.

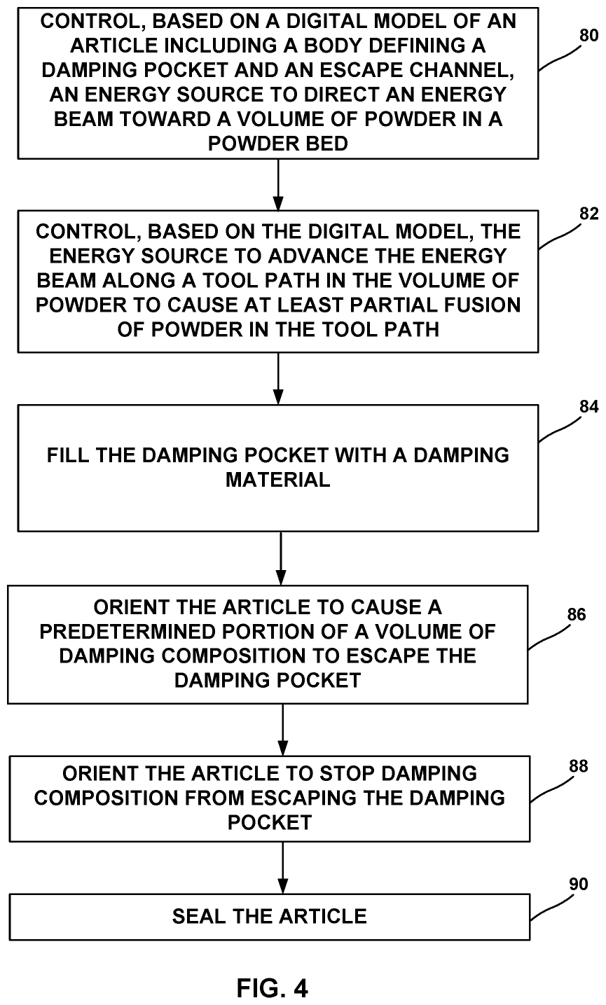

FIG. 4 is a flow diagram illustrating an example technique for additive manufacturing of example articles including damping pockets. While the example technique of FIG. 4 is described with reference to article 10 of FIGS. 1A to 1D and system 50 of FIG. 3, the example technique may be used to form any example articles according to the disclosure using any example systems according to the disclosure.

The example technique of FIG. 4 includes fabricating or forming article 10 by additively depositing or additively manufacturing article 10 (or article 30) in powder bed 58 or otherwise on or adjacent platform 60. As discussed with reference to FIG. 1A above, article 10 includes body 12. Body 12 or article 10 (or article 30) defines at least one damping pocket 14, at least one escape channel 16 (or 16A), and at least one body opening 18 (or 18A). At least one damping pocket 14 includes a predetermined volume of damping material 20. At least one damping pocket 14 is fluidically coupled to at least one body opening 18 (or 18A) by at least one escape channel 16 (or 16A).

In some examples, additively manufacturing article 10 includes controlling, based on digital model 10A of article 10, energy source 52 to direct energy beam 56 at a focal region on a surface of partially fabricated article 10, or in a region of powder bed 58, or on or adjacent build platform 60 (80). For example, computing device 54, or controller 62, may control energy source 52 (80). In examples in which system 10 does not include a powder bed 58, additively manufacturing article 10 may include controlling both energy source 52 to direct energy beam 56 and material source 64 to direct material stream 66 at the focal region. In some examples, additively manufacturing article 10 includes moving the focal region along a predetermined path, for example, a tool path. For example, controller 62 may control energy beam 52 (and optionally, material stream 64), such that energy beam 56 interacts with portions, volumes, or packets of material from powder bed 58 (or from material stream 66), for example, by fusing, solidifying, or sintering material from material stream 66 at a series of focal regions along the tool path, to deposit volumes of material along the tool path.

In some examples, the example technique of FIG. 4 includes controlling, by computing device 54 (or controller 62), based on digital model 10A, energy source 52 to advance energy beam 56 along at least one tool path in the volume of powder (in powder bed 58) to cause at least partial fusion of powder in the at least one tool path (82). Thus, partially built or fully formed article 10 may include at least partially fused powder in the at least one tool path. In some examples, the at least one tool path may form successive layers or portions of material that ultimately form article 10. For example, computing device 54 or controller 62 may direct energy beam 52 (and optionally, material source 64) to fuse material (for example, powder) in layers, ultimately forming article 10 (82).

In some examples, controller 62 may direct energy source 52 to cause least partial fusion of powder in a predetermined build direction, for example, a vertical direction pointing away from build platform 60 (against a direction of gravity). Thus, controller 62 may direct material along the build direction, beginning with layers of material on or adjacent a major surface of build platform 60 and then continuing to fuse layers that are successively farther away from the major surface.

In some examples, digital representation 10A includes a representation of damping pocket 14, escape channel 16, and body opening 18. Controller 62 may direct energy beam 56 (or material stream 66) around regions defining damping pocket 14, escape channel 16 or body opening 18, for example, by fusing layers that define successive cross-sections of predetermined channels that eventually define damping pocket 14, escape channel 16 or body opening 18.

The example technique of FIG. 4 may include filling at least one damping pocket 14 with a predetermined volume of damping material 20 (84). For example, controller 62 may control energy beam 56 to refrain from fusing material at locations within damping pocket 14, escape channel 16, and body opening 18. Thus, in some examples, filling at least one damping pocket 14 with the predetermined volume of damping material 20 (84) may include controlling, by controller 62, based on digital model 10A, energy source 52 to reduce or avoid fusion of powder in at least a pocket region of the volume of powder to leave damping material 20 in the pocket region. The pocket region may define at least a portion of damping pocket 14. For example, damping material 20 may include residual unfused or partially fused powder of material used to form body 12 of article 10.

In some examples, additively manufacturing article 10 may include controlling, by controller 62, based on digital model 10A, material source 64 to deliver damping material 20 in at least a pocket region of the volume of powder to leave damping material 20 in the pocket region. Thus, in some examples, filling at least one damping pocket 14 with the predetermined volume of damping material 20 (84) may include controlling, by controller 62, based on digital model 10A, material source 62 to deliver damping material 20 in at least a pocket region of the volume of powder to leave the damping material in the pocket region.

In some examples, damping material 20 may include residual unfused or partially fused powder of material used to form body 12 of article 10. In other examples, damping material 20 may include a composition different from powder or material used to form body 12 of article 10. In some examples, the damping material 20 delivered by material source 64 may include at least one frangible shell 22.

In some examples, article 10 may be machined in addition to being additively manufactured. For example, article 10 may be machine to at least partially define one or more of damping pocket 14, escape channel 16, or body opening 18. In some examples, machining may be used to smoothen, refine, or polish one or more regions or portions of article 10. Such post-processing machining may promote flow of material from damping pocket 14 through escape channel 16 or body opening 18.

After article 10 is formed, article 10 may include damping material 20 substantially occupying a volume of damping pocket 14. In some such examples, article 10 may be further processed to allow some of the damping material 20 to escape from damping pocket 14. For example, the example technique of FIG. 4 may include orienting article 10 to cause predetermined portion 20A of the volume of damping material 20 to escape damping pocket 14 (86). In some examples, the orienting may include inclining or inverting article 10 such that gravity causes damping material 20 to flow from damping pocket 14 through escape channel 16 and out of body 12 through body opening 18. As described reference to FIGS. 1A to 1D, escape channel 16 may be dimensioned and configured to only allow predetermined portion 20A of damping material 20 to escape from damping pocket 14. After allowing predetermined portion 20A to escape, the example technique may include orienting article 10 to stop damping material 20 from escaping damping pocket 14 (88). For example, the orienting may cause body opening 18 to be away from or oppose the direction of gravity, so that damping material 20 cannot depart from body opening 18. The example technique may include repeating steps 84 and 86 to allow multiple portions 20A of damping material 20 to escape from damping pocket 14.

After sufficient damping material 20 remains in damping pocket to define void 24, article 10 may be sealed (90). For example, at least one of escape channel 16 or body opening 18 may be sealed with sealing composition 26, to prevent further escape of damping material 20.

Thus, example techniques may include additive manufacturing to form example articles according to the disclosure, for example, article 10 including body 12 defining damping pocket 14, escape channel 16, and body opening 18.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, for example, a non-transitory medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

Clause 1: An article including:

a body, where the body defines:
at least one damping pocket;
at least one body opening defined in an outer surface of the body; and
at least one escape channel, where the at least one damping pocket is fluidically coupled to the at least one body opening by the at least one escape channel; and
   where the article includes a predetermined volume of damping material enclosed in the at least one damping pocket.

Clause 2: The article of clause 1, where the at least one escape channel is dimensioned to allow only a predetermined portion of the predetermined volume of the damping material to escape the damping pocket through the at least one body opening.

Clause 3: The article of clause 1 or 2, where the at least one damping pocket defines a pocket volume, and where the predetermined volume of damping material is less than the pocket volume by a predetermined amount.

Clause 4: The article of any of clauses 1 to 3, where the damping material includes at least one of unfused powder, partially fused powder, a damping component including at least partially fused powder, or at least one frangible shell.

Clause 5: The article of any of clauses 1 to 4, where the at least one escape channel includes a plurality of channel segments along an undulating, sinuosoid-like, sawtooth, or zig-zag path.

Clause 6: The article of any of clauses 1 to 5, where the body opening defines a slit in an outer surface of the body.

Clause 7: The article of any of clauses 1 to 6, where the body is a unitary body.

Clause 8: The article of any of clauses 1 to 7, where the article includes a seal configured to close the at least one body opening.

Clause 9: The article of any of clauses 1 to 8, where the body further defines at least one escape pocket, where the at least one escape pocket is fluidically coupled to the at least one damping pocket by the at least one escape channel, where the at least one escape pocket is fluidically coupled to the at least one body opening, and where the at least one escape pocket is dimensioned to receive a predetermined portion of the damping material from the damping pocket to reduce an amount of the damping material in the damping pocket to a predetermined volume of damping material remaining in the damping pocket.

Clause 10: The article of clause 9, where the escape pocket is positioned relative to the at least one damping pocket and the at least one body opening to allow only the predetermined portion of the damping material to escape the damping pocket through the at least one body opening.

Clause 11. A technique including:

additively manufacturing an article including a body, where the body defines:
at least one damping pocket;
at least one body opening defined in an outer surface of the body; and
at least one escape channel, where the at least one damping pocket is fluidically coupled to the at least one body opening by the at least one escape channel; and

filling the at least one damping pocket with a predetermined volume of damping material.

Clause 12: The technique of clause 11, where additively manufacturing the article includes:

controlling, by a computing device, based on a digital model of the article, an energy source to direct an energy beam toward a volume of powder in a powder bed; and

controlling, by the computing device, based on the digital model, the energy source to advance the energy beam along at least one tool path in the volume of powder to cause at least partial fusion of powder in the at least one tool path, where the article includes at least partially fused powder in the at least one tool path.

Clause 13: The technique of clause 12, where filling the at least one damping pocket with the predetermined volume of damping material includes controlling, by the computing device, based on the digital model, the energy source to reduce or avoid fusion of powder in at least a pocket region of the volume of powder to leave a damping material in the pocket region.

Clause 14. The technique of clause 12, where filling the at least one damping pocket with the predetermined volume of damping material includes controlling, by the computing device, based on the digital model, a material source to deliver a damping material in at least a pocket region of the volume of powder to leave the damping material in the pocket region.

Clause 15. The technique of any of clauses 11 to 14, where the damping material includes at least one of unfused powder, partially fused powder, a damping component including at least partially fused powder, or at least one frangible shell.

Clause 16: A system including:

an additive manufacturing tool; and

a computing device configured to control the additive manufacturing tool to additively manufacture an article including a body, where the body defines:
at least one damping pocket, where the at least one damping pocket includes a predetermined volume of damping material,
at least one body opening defined in an outer surface of the body, and
at least one escape channel, where the at least one damping pocket is fluidically coupled to the at least one body opening by the at least one escape channel, and where the computing device is configured to control the additive manufacturing tool to fill the at least one damping pocket with a predetermined volume of damping material.

Clause 17: The system of clause 16, where the additive manufacturing tool includes an energy source, and where the computing device is configured to:

control, based on a digital model of an article, the energy source to direct an energy beam toward a volume of powder in a powder bed, and
control based on the digital model, the energy source to advance the energy beam along at least one tool path in the volume of powder to cause at least partial fusion of powder in the at least one tool path, where the article includes at least partially fused powder in the at least one tool path.

Clause 18: The system of clause 17, where the computing device is further configured to fill the at least one damping pocket by controlling, based on the digital model, the energy source to reduce or avoid fusion of powder in at least a pocket region of the volume of powder to leave a damping material in the pocket region.

Clause 19: The system of clause 17, where the additive manufacturing tool further includes a material source, where the computing device is further configured to fill the at least one damping pocket by controlling, based on the digital model, the material source to deliver a damping material in at least a pocket region of the volume of powder to leave the damping material in the pocket region.

Clause 20. The system of any of clauses 16 to 19, where the damping material includes at least one of unfused powder, partially fused powder, a damping component comprising at least partially fused powder, or at least one frangible shell.

Various examples have been described. These and other examples are within the scope of the following claims.

What is claimed is:

1. An article comprising:
a body, wherein the body defines:
at least one damping pocket;
at least one body opening defined in an outer surface of the body; and
at least one escape channel, wherein the at least one damping pocket is fluidically coupled to the at least one body opening by the at least one escape channel; and
a predetermined volume of damping material enclosed in the at least one damping pocket.

2. The article of claim 1, wherein the at least one escape channel is dimensioned to allow only a predetermined portion of the predetermined volume of the damping material to escape the damping pocket through the at least one body opening.

3. The article of claim 1, wherein the at least one damping pocket defines a pocket volume, and wherein the predetermined volume of damping material is less than the pocket volume by a predetermined amount.

4. The article of claim 1, wherein the damping material comprises at least one of unfused powder, partially fused powder, a damping component comprising at least partially fused powder, or at least one frangible shell.

5. The article of claim 1, wherein the at least one escape channel comprises a plurality of channel segments along an undulating, sinuosoid-like, sawtooth, or zig-zag path.

6. The article of claim 1, wherein the body opening defines a slit in the outer surface of the body.

7. The article of claim 1, wherein the body is a unitary body.

8. The article of claim 1, wherein the article includes a seal configured to close the at least one body opening.

9. The article of claim 1, wherein the body further defines at least one escape pocket, wherein the at least one escape pocket is fluidically coupled to the at least one damping pocket by the at least one escape channel, wherein the at least one escape pocket is fluidically coupled to the at least one body opening, and wherein the at least one escape pocket is dimensioned to receive a predetermined portion of the damping material from the damping pocket to reduce an amount of the damping material in the damping pocket to a predetermined volume of damping material remaining in the damping pocket.

10. The article of claim 9, wherein the escape pocket is positioned relative to the at least one damping pocket and the at least one body opening to allow only the predetermined portion of the damping material to escape the damping pocket through the at least one body opening.

11. A method comprising:
additively manufacturing an article comprising a body, wherein the body defines:
at least one damping pocket;
at least one body opening defined in an outer surface of the body; and
at least one escape channel, wherein the at least one damping pocket is fluidically coupled to the at least one body opening by the at least one escape channel; and
filling the at least one damping pocket with a predetermined volume of damping material.

12. The method of claim 11, wherein additively manufacturing the article comprises:
controlling, by a computing device, based on a digital model of the article, an energy source to direct an energy beam toward a volume of powder in a powder bed; and
controlling, by the computing device, based on the digital model, the energy source to advance the energy beam along at least one tool path in the volume of powder to cause at least partial fusion of powder in the at least one tool path, wherein the article comprises at least partially fused powder in the at least one tool path.

13. The method of claim 12, wherein filling the at least one damping pocket with the predetermined volume of damping material comprises controlling, by the computing device, based on the digital model, the energy source to reduce or avoid fusion of powder in at least a pocket region of the volume of powder to leave a damping material in the pocket region.

14. The method of claim 12, wherein filling the at least one damping pocket with the predetermined volume of damping material comprises controlling, by the computing device, based on the digital model, a material source to deliver a damping material in at least a pocket region of the volume of powder to leave the damping material in the pocket region.

15. The method of claim 14, wherein the damping material comprises at least one of unfused powder, partially fused powder, a damping component comprising at least partially fused powder, or at least one frangible shell.

16. A system comprising:
an additive manufacturing tool; and
a computing device configured to control the additive manufacturing tool to additively manufacture an article comprising a body, wherein the body defines:
at least one damping pocket, wherein the at least one damping pocket comprises a predetermined volume of damping material,
at least one body opening defined in an outer surface of the body, and
at least one escape channel, wherein the at least one damping pocket is fluidically coupled to the at least one body opening by the at least one escape channel,
and wherein the computing device is configured to control the additive manufacturing tool to fill the at least one damping pocket with a predetermined volume of damping material.

17. The system of claim 16, wherein the additive manufacturing tool comprises an energy source, and wherein the computing device is configured to:
control, based on a digital model of an article, the energy source to direct an energy beam toward a volume of powder in a powder bed, and
control based on the digital model, the energy source to advance the energy beam along at least one tool path in the volume of powder to cause at least partial fusion of powder in the at least one tool path, wherein the article comprises at least partially fused powder in the at least one tool path.

18. The system of claim 17, wherein the computing device is further configured to fill the at least one damping pocket by controlling, based on the digital model, the energy source to reduce or avoid fusion of powder in at least a pocket region of the volume of powder to leave a damping material in the pocket region.

19. The system of claim 17, wherein the additive manufacturing tool further comprises a material source, wherein the computing device is further configured to fill the at least one damping pocket by controlling, based on the digital model, the material source to deliver a damping material in at least a pocket region of the volume of powder to leave the damping material in the pocket region.

20. The system of claim 19, wherein the damping material comprises at least one of unfused powder, partially fused powder, a damping component comprising at least partially fused powder, or at least one frangible shell.
